(19) United States
(12) Patent Application Publication
(10) Pub. No.: US 2025/0321732 A1
(43) Pub. Date: Oct. 16, 2025

(54) METHOD AND SYSTEM OF SOFTWARE COMPONENT IDENTIFICATION IN EMBEDDED SYSTEM FIRMWARE

(71) Applicant: Delta Electronics, Inc., Taoyuan City (TW)

(72) Inventors: Edwin Lupito LOE, Taoyuan City (TW); Ti Hsun SUNG, Taoyuan City (TW); Yi Ching LUI, Taoyuan City (TW); Wei Jen LIU, Taoyuan City (TW)

(73) Assignee: Delta Electronics, Inc., Taoyuan City (TW)

(21) Appl. No.: 18/764,258

(22) Filed: Jul. 4, 2024

(30) Foreign Application Priority Data
Apr. 16, 2024 (CN) 202410454920.4

(51) Int. Cl. G06F 8/71

(52) U.S. Cl. CPC G06F 8/71

(57) ABSTRACT

A method and system of software component identification in an embedded system firmware are disclosed. The method comprises: extracting the indicator files from a firmware file; extracting features from each indicator file, the features comprising: a hash value, semantic information, control flow graph information, and function-level feature information; comparing the features with a database, comprising a plurality of known software components, along with the features of each known indicator file within each known software component, to derive an indicator file identification result for each indicator file; and based on the indicator file identification results, determining a software component identification result of the firmware file.

### CROSS REFERENCE TO RELATED APPLICATIONS

This application claims the benefit of priority of China Patent Application No. 202410454920.4 filed on Apr. 16, 2024. The contents of the above application is all incorporated by reference as if fully set forth herein in its entirety.

### FIELD OF DISCLOSURE

The present invention relates to the field of software component identification, in particular to a method and system of software component identification in an embedded system firmware.

### BACKGROUND

Due to numerous software supply chain attacks causing serious security issues, the regulatory requirements for supply chain security have been increasing. Providing a software bill of materials has become a mandatory requirement for many end product manufacturers towards their supply chain vendors. Through the software bill of materials, a list of internal development as well as third-party or open-source software contained in the software product is outlined, detailing names, versions, sources, dependencies, and suppliers, thus increasing transparency in the software supply chain and helping companies have better risk management in the software development and supply processes. Hence, the completeness and accuracy of the software bill of materials are crucial, and it heavily relies on precise software component identification tools.

### SUMMARY OF DISCLOSURE

In view of this, the present invention provides a method and system of software component identification in an embedded system firmware. In particular, even in the absence of the original source code, the software component identification can still be accomplished sorely based on the embedded system firmware file.

This invention provides a method of software component identification in an embedded system firmware, which comprises: receiving a firmware file; extracting an indicator file from the firmware file; extracting features from the indicator file, comprising a hash value, semantic information, control flow graph information, and function-level feature information; comparing the features of the indicator file with a database to derive an indicator file identification result; and determining the software component identification result of the firmware file based on the indicator file identification results of each indicator file in the firmware file.

This invention provides a system of software component identification in an embedded system firmware, which comprises: an indicator file extraction module to receive a firmware file and extract an indicator file from the firmware file; a feature extraction module to extract features of the indicator file from the indicator file, wherein the features comprise a hash value, semantic information, control flow graph information, and function-level feature information; a database comprising a plurality of known software components, along with the features of each known indicator file within each known software component; an indicator file identification module to compare the features of the indicator file with the database to derive an indicator file identification result; and a software component identification module to determine the software component identification result of the firmware file based on the indicator file identification results of the plurality of indicator files.

### BRIEF DESCRIPTION OF DRAWINGS

FIG. 1 illustrates a flowchart of a method of software component identification upon a firmware file according to an embodiment of the present invention.

FIG. 2 illustrates a flowchart of extracting features from an indicator file according to an embodiment of the present invention.

FIG. 3 illustrates a flowchart of extracting function-level feature information and control flow graph information according to an embodiment of the present invention.

FIG. 4 illustrates a flowchart of comparing the features of the indicator file with a database to derive an indicator file identification result according to an embodiment of the present invention.

FIG. 5 illustrates a block diagram of a system of software component identification upon a firmware file according to an embodiment of the present invention.

FIG. 6 illustrates a block diagram of a feature extraction module according to an embodiment of the present invention.

FIG. 7 illustrates a block diagram of a function-level feature information and control flow graph information extraction module according to an embodiment of the present invention.

### DETAILED DESCRIPTION

The exemplary embodiments of the present invention will now be elaborated upon with reference to the accompanying drawings. However, it should be noted that these exemplary embodiments can take many forms and should not be interpreted as being confined to the embodiments set forth herein. Instead, these embodiments are provided to ensure that this invention is comprehensive and thorough, and effectively communicates the full scope of the invention to those skilled in the art. The drawings are merely schematic illustrations of the invention, and the components depicted in the drawings are not necessarily drawn to scale. Identical reference numerals in the drawings denote identical or similar parts, hence, repeated descriptions thereof will be omitted for brevity.

This invention provides a method and system of software component identification in an embedded system firmware. In particular, even in the absence of the original source code, the software component identification can still be accomplished sorely based on the embedded system firmware file. For illustration purposes, the firmware file of a Linux-based embedded system is used as an example.

Please refer to FIG. 1, which illustrates a flowchart of a method of software component identification upon a firmware file according to an embodiment of the present invention. The software component identification method comprises the following steps.

Step S10: Receive a firmware file, especially one that contains many third-party software components. For example, the firmware file could be utilized within a customized Linux system environment, especially designed for embedded system products such as routers, switches, wireless access points, electric vehicle charging stations, etc. In such scenarios, the firmware file frequently contains variety of third-party software/libraries and open-source software. Those files are typically located in specific folders within the embedded Linux file system, such as /bin, /sbin, /lib, /usr/bin, etc. In an embedded system, file systems such as JFFS2, UBIFS, YAFFS, or SquashFS are employed to manage data on flash memory devices, and the firmware is packaged in formats such as .bin, .iso, .img, or .zip for firmware updates.

Step S20: Extract indicator files from the firmware file. By using firmware extraction tools such as binwalk or decompression tools like zip, various software components within the firmware file are extracted, including the original file content, file names, and folder structure. A software component contains various type of files, among which the executable files, the library files, and the configuration files are referred to as indicator files in an embodiment of the present invention. By extracting files contained in the firmware file and screening them based on file folder names, file extensions, and other criteria, a list of indicator files is obtained. According to these indicator files, the identification of a software component will be achieved.

Step S30: Extract the package management file from the firmware file and derive the software component identification result according to the package management file. Some Linux distribution operating systems use a package management system for developers to install, remove, upgrade, and manage software packages. For example, Red Hat Linux distribution uses the rpm package management system, Debian uses the dpkg package management system, and OpenWRT uses the opkg package management system. In such a case, the content of the firmware file will contain a package management file. Taking the opkg package management system as an example, the .control file and .list file serve as the package management files. The .control file records the basic information of the package, while the .list file contains the file list within the package. Table 1 and Table 2 illustrate examples. Table 1 displays the example content of a .control file named ‘base-files.control’. The .control file contains essential information, including package name, version, and dependency relationships. Meanwhile, Table 2 displays the example content of a .list file named ‘base-files.list’. By referencing the content in the .control file, the software component can be identified, as an example, which is the “base-files” for the case of Table 1. Consequently, the indicator files contained in the .list file can be excluded from the indicator file list generated in step S20. Nevertheless, if necessary, these indicator files can remain included in the indicator file list. The advantage is that the accuracy of the information in the package management files can be verified through the software component identification mechanism of the present invention.

TABLE 1
Example content of a .control file named ‘base-files.control.’

```
base-files.control
Package: base-files
Version: 194.3-r8077-7cbbab7246
Depends: libc, netifd, procd, jsonfilter, usign, openwrt-keyring, fstools,
fwtool
Source: package/base-files
License: GPL-2.0
Section: base
Architecture: arm_cortex-a15_neon-vfpv4
Installed-Size: 36533
Description: This package contains a base filesystem and system scripts for
OpenWrt.
  .
  .
  .
```

TABLE 2
Example content of a .list file named ‘base-files.list.’

```
base-files.list
/etc/openwrt_version
/etc/banner.failsafe
/etc/resolv.conf
  .
  .
  .
/etc/mtab
/etc/init.d/boot
/lib/functions/preinit.sh
```

Step S40: Conduct feature extraction on each indicator file. Utilizing the features extracted from an indicator file, search a database to retrieve multiple candidate indicator files and calculate a similarity score for identifying the indicator file. In an embodiment, the features of the indicator file comprise a hash value, semantic information, control flow graph information, and function-level feature information. The detailed steps of the feature extraction on each indicator file are described as follows.

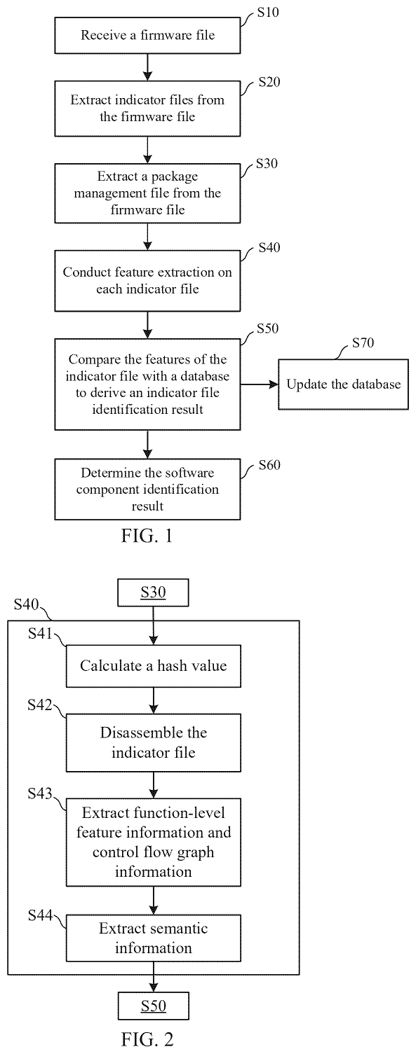

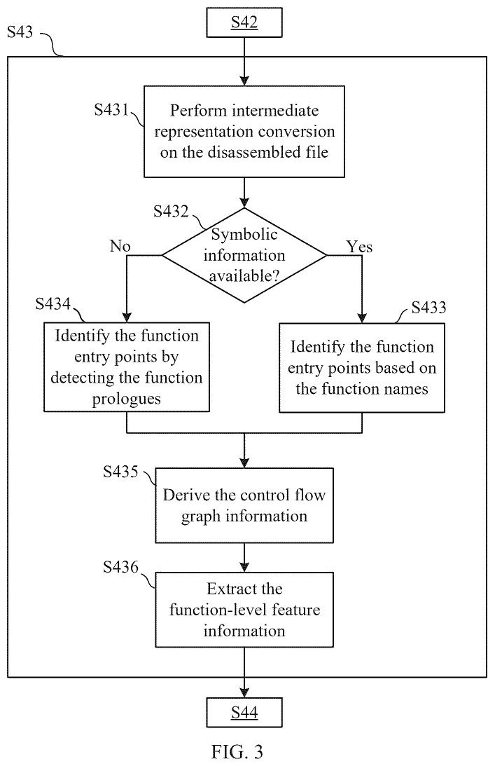

Please refer to FIG. 2, which illustrates a flowchart of an indicator file feature extraction process according to an embodiment of the present invention. Step S41: Calculate a hash value. The content of the indicator file is fed into a hash function to calculate a hash value, serving as a digital signature for the indicator file. Hash functions such as MD5, SHA1, or others are all applicable to the present invention.

Step S42: Disassemble the indicator file to generate a disassembled file. Disassembler tools such as IDA Pro, Ghidra, etc., are all applicable to the present invention.

Step S43: Extract function-level feature information and control flow graph information. The detailed steps are as follows. Please refer to FIG. 3, which illustrates a flowchart of extracting function-level feature information and control flow graph information according to an embodiment of the present invention, comprising the following steps. Step S431: Perform intermediate representation conversion on the disassembled file to convert assembly code into intermediate representation. Step S432: From the intermediate representation, check if the indicator file preserves symbolic information such as function name, library name, variable name, etc. If the symbolic information is available, proceed to step S433 to identify the function entry points based on the function names. The function name serves as a label, with its location representing the function entry point. If not, proceed to step S434 to identify the function entry points by identifying the function prologues. Typically, a section of assembly code at the beginning of a function prepares the stack and registers for internal use, known as the function prologue. Based on the intermediate representation, the corresponding CPU architecture can be determined. Then, based on the intermediate representation of the function prologue corresponding to that CPU architecture, detect all function prologues to identify the function entry points. Once the function entry points are identified in either step S433 or step S434, subsequent processing can be conducted on each function individually.

A control flow graph is composed of nodes and directed edges, employed to depict the control flow within a function. Each node represents a basic block or a statement, while directed edges represent control flow transitions between nodes. In step S435, the initial task is to detect all intermediate representations associated with jumps, branches, or returns. Subsequently, the control flow graph of the function can be derived, and the control flow graph information, including nodes, directed edges, and caller and callee information of each node, can be acquired.

Step S436: Extract function-level feature information, which comprises extracting readable strings within functions, and if the symbolic information is available in the intermediate representation, extracting the names of each function as well. Table 3 provides examples of function names discovered in a library file, named ‘libncursesw.so.5.9’, of the software component ‘libncursesw’. In addition to the function names, these readable strings may include variable names, input/output parameter types, etc., associated with the function, serving as features for function identification. It is noted that standardization processing might be required for extracting readable strings to normalize memory addresses and registers.

TABLE 3
Example of function names contained in an
indicator file, named ‘libncursesw.so.5.9’.

```
Indicator file: libncursesw.so.5.9
“memcpy”
“malloc”
“atof”
  .
  .
  .
```

Please refer back to FIG. 2. Step S44: Extract semantic information. The software typically includes internal strings and often relies on external libraries. By parsing the content of the indicator file, all readable strings can be extracted, along with the external library names obtained in step S43, constituting the semantic information of the indicator file. Table 4 presents an example of readable strings contained in an indicator file, named ‘libncursesw.so.5.9’, of the software component ‘libncursesw’. Table 5 presents an example of external library names contained in the indicator file ‘libncursesw.so.5.9’. Since the semantic information consists entirely of strings, this facilitates similarity calculations. This semantic information will be utilized to search for the most similar indicator file in the database, which will be elaborated on in detail.

TABLE 4
Example of the readable strings contained in
an indicator file, named ‘libncursesw.so.5.9’.

```
Indicator file: libncursesw.so.5.9
“_fini”
“TABSIZE”
“_nc_hash_map”
  .
  .
  .
```

TABLE 5
Example of external library names contained
in the indicator file ‘libncursesw.so.5.9’.

```
Indicator file: libncursesw.so.5.9
“_{——}imp_strcpy”
“_{——}imp_ioctl”
“_{——}imp_memmove”
  .
  .
  .
```

Please refer back to FIG. 1. In step S50, the features of the indicator file are compared with a pre-established database to derive the indicator file identification result. The database contains various known software components, along with the features of each known indicator file within each known software component. The extraction method of the features of each indicator file is the same as in step S40. In step S50, each indicator file is processed individually, as elaborated below.

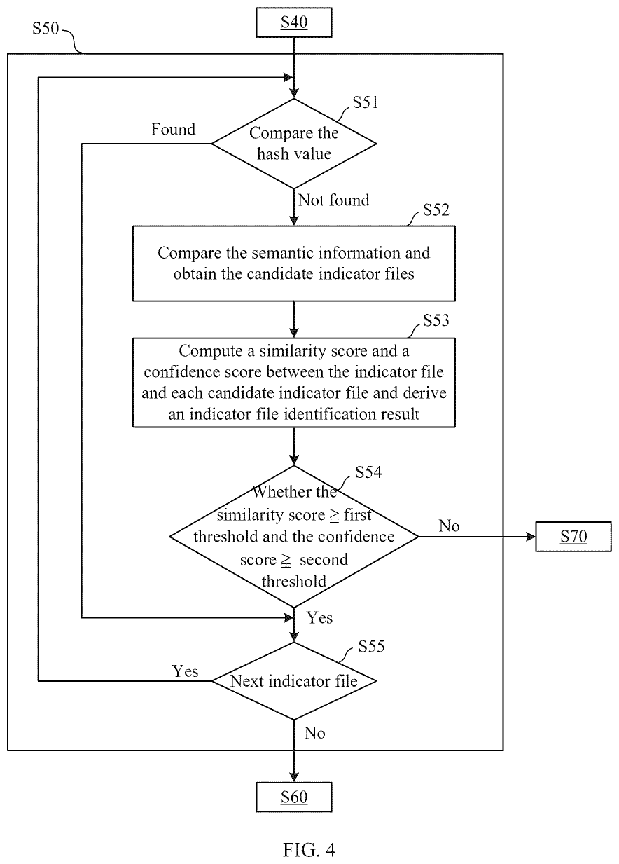

Please refer to FIG. 4, which illustrates a flowchart of comparing the features of the indicator file with the database to derive the indicator file identification result. Step S51: Compare the hash value of the indicator file with the database. If the hash value is found in the database, the known indicator file associated with the hash value in the database is designated as the indicator file identification result, thereby completing the identification of the indicator file. Subsequently, the next indicator file can then be processed.

Step S52: Compare the semantic information of the indicator file with the database to retrieve the top N most similar known indicator files in the database, where N is an integer. For illustrative purpose, the following explanation will use the integer N as 5. It is understood that N can be any other integer value for the present invention. Since the semantic information of the indicator file is in string form, similarity measurement algorithms such as Jaccard can be employed to calculate the similarity score between the semantic information of the indicator file and the semantic information of each known indicator file in the database. Based on the similarity score, the top 5 most similar known indicator files in the database are obtained as candidate indicator files.

Step S53: Compute a similarity score and a confidence score between the indicator file and each candidate indicator file. For extracting the control flow graph information and function-level feature information, tools such as ‘graph matching networks with machine learning mechanisms’ and/or bindiff tools can be employed for measuring similarity. A first set of similarity score and confidence score between the indicator file and each candidate indicator file is calculated based on the control flow graph information. A second set of similarity score and confidence score between the indicator file and each candidate indicator file is calculated based on the function-level feature information. A weighted average of the first and second set of similarity scores is determined as the overall similarity score between the indicator file and each candidate indicator file. Likewise, a weighted average of the first and second set of confidence scores is determined as the confidence score between the indicator file and each candidate indicator file. Ultimately, the candidate indicator file with the highest similarity and confidence score is selected as the indicator file identification result.

Using bindiff as an example of a similarity measurement tool, the bindiff tool can compute a similarity score and a confidence score for functions within one file compared to functions in another file, thereby generating a similarity score and a confidence score between the two files. The bindiff tool encompasses various algorithms, such as function: hash matching, function: edges flowgraph MD index, function: call sequence matching (exact), function: call sequence matching (topology), function: call sequence matching (sequence), basicBlock: edges prime product, etc. Each algorithm can produce a similarity value. Based on empirical observations, the reliability of each algorithm varies, so these similarity values are weighted and averaged to derive a similarity score. More reliable algorithms are assigned higher weight values, while less reliable algorithms are assigned lower weight values. Additionally, besides providing a similarity score, the bindiff tool also produces a confidence score to indicate the level of confidence in the corresponding similarity score.

Step S54: If the similarity score of the indicator file identification result is greater than or equal to a first threshold, and the confidence score is greater than or equal to a second threshold, then the indicator file identification result is deemed valid. Proceed to step S55 to verify if there is another indicator file to process, otherwise proceed to step S60. If the similarity score falls below the first threshold, or the confidence score falls below the second threshold, then the indicator file identification result is deemed invalid, indicating that the indicator file is new and distinct from all known indicator files in the database. Then, proceed to step S70 for further processing.

Please refer back to FIG. 1. Step S60: Generate the software component identification result. For each indicator file in the firmware file, the indicator file identification result obtained through steps S40 and S50 can be used to search the database and retrieve the associated software component. For instant, the software component associated with the indicator file ‘libncursesw.so.5.9’ is ‘ncurses’ based on the database. The software components associated with identified indicator files, along with the software components identified through package management files in step S30, constitute the software component identification result of the firmware file. Finally, based on the identified software components, and their detailed information such as name, version, source, dependencies, vendor, etc., which are stored in the database, a software bill of materials is generated in SPDX or CycloneDX format (not shown in the figure).

Step S70: Update the database. Once the indicator file is identified as being distinct from all the known indicator files in the database, the relevant data of the indicator file is added to the database after figuring out which software component the indicator file belongs to, wherein the relevant data includes name, version, source, dependencies, and suppliers of the software component, as well as the features extracted from the indicator file in step S40. By this way, the update makes the database more comprehensive, thereby enabling more accurate identification of software component.

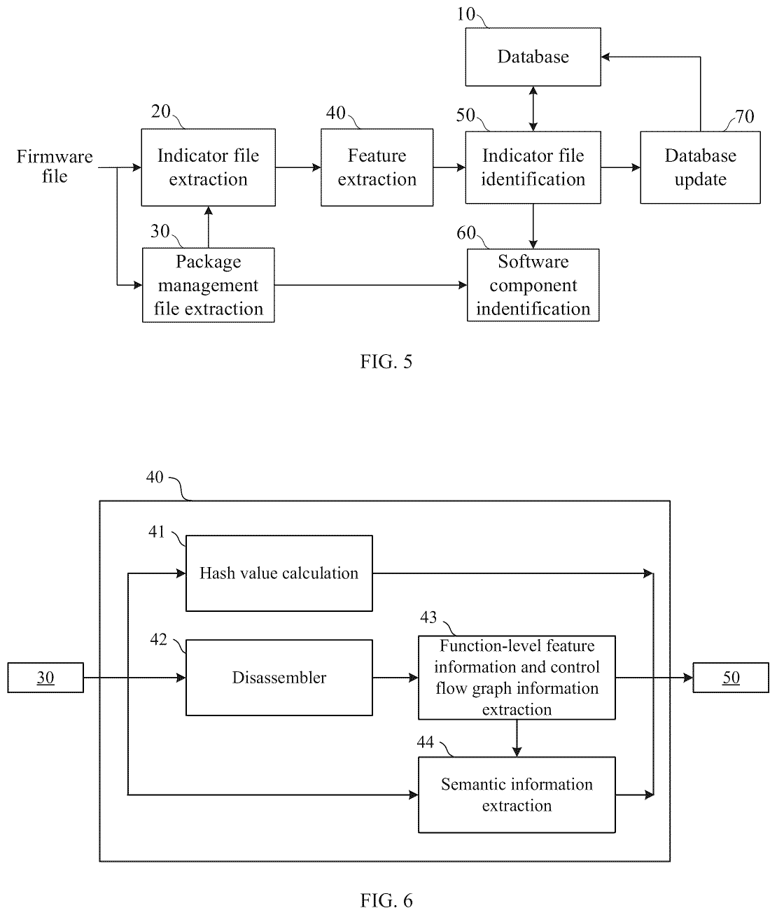

Please refer to FIG. 5, which illustrates a block diagram of a system of software component identification upon a firmware file in an embodiment of the present invention. The software component identification system comprises: a database 10, an indicator file extraction module 20, a package management file extraction module 30, a feature extraction module 40, an indicator file identification module 50, a software component identification module 60, and a database update module 70. The indicator file extraction module 20 receives a firmware file, extracts indicator files from the firmware file, and operates in the same manner as the aforementioned step S20. The package management file extraction module 30 extracts package management files from the firmware file, derives software component identification results from the package management files, and operates in the same manner as the aforementioned step S30. The feature extraction module 40 extracts the features of the indicator files from the indicator file extraction module. The database 10 is a pre-established database containing known software components, along with the features of each known indicator file within each known software component. The features of each indicator file are sourced from the feature extraction module 40. The indicator file identification module 50 is employed to compare the features of the indicator file with the database, derive an indicator file identification result, and operates in the same manner as the aforementioned step S50.

The software component identification module 60 determines the software component identification result of the firmware file based on the indicator file identification result of each indicator file within the firmware file and operates in the same manner as the aforementioned step S60. The database update module 70 adds a new entry of indicator file data to the database when the similarity score of the indicator file identification result in the indicator file identification module 50 is below a first threshold or the confidence score is below a second threshold. The database update module 70 operates in the same manner as the aforementioned step S70.

Please refer to FIG. 6, which illustrates a block diagram of the feature extraction module in an embodiment of the present invention. The feature extraction module 40 comprises: a hash value calculation module 41, a disassembler module 42, a function-level feature information and control flow graph information extraction module 43, and a semantic information extraction module 44. The hash value calculation module 41 is utilized to calculate the hash value of the indicator file. The disassembler module 42 disassembles the indicator file, resulting in a disassembled file. The function-level feature information and control flow graph information extraction module 43 extracts the following information from the disassembled file: function-level feature information, control flow graph information, and external library name information. The semantic information extraction module 44 analyzes the content of the indicator file to extract all readable strings, along with the external library name information produced by the function-level feature information and control flow graph information extraction module 43, to obtain the semantic information of the indicator file.

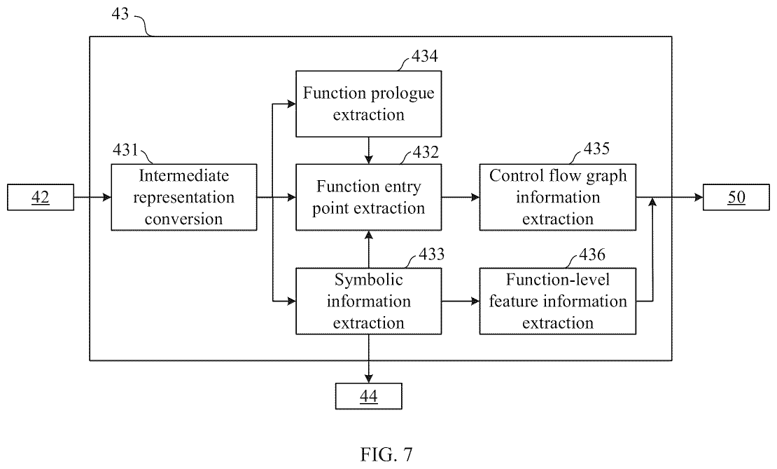

Please refer to FIG. 7, which illustrates a block diagram of the function-level feature information and control flow graph information extraction module in an embodiment of the present invention. The function-level feature information and control flow graph information extraction module 43 comprised: an intermediate representation conversion module 431, a function entry point extraction module 432, a symbolic information extraction module 433, a function prologue extraction module 434, a control flow graph information extraction module 435, and a function-level feature information extraction module 436. The intermediate representation conversion module 431 converts the disassembled file into an intermediate representation file. The symbolic information extraction module 433 is used to extract symbolic information such as function name, external library name, variable name from the intermediate representation file, where the external library name is output to the semantic information extraction module 44. However, if the source code was compiled without preserving symbolic information, the intermediate representation file will not contain any symbolic information for extraction, rendering the symbolic information extraction module 433 unable to output any information. The function prologue extraction module 434 first identifies the corresponding CPU architecture based on the intermediate representation and then detects the function prologue for each CPU architecture. The function entry point extraction module 432, when the intermediate representation contains symbolic information, extracts the function entry points based on the output of the symbolic information extraction module 433; otherwise, it produces the function entry points based on the output of the function prologue extraction module 434.

The control flow graph message extraction module 435 is based on the output of the function prologue extraction module 434, extracting each function entry point in order to process each function individually. By detecting all jump, branch, or return-related intermediate representations, the module derives the control flow graph of the function and control flow graph messages, comprising basic block, node, directed edges, caller, and callee information. The function-level feature information extraction module 436 is used to extract readable strings in functions, perform necessary memory address and register standardization processing, and extract function names when the symbolic information is available in the intermediate representation.

The aforementioned details represent only specific implementations of the present invention. However, the protection scope of the present invention is not limited thereto. Any modifications or replacements that can be easily devised by those skilled in the art within the technical scope of the present invention should all fall within the protection scope of the present invention. Consequently, the protection scope of the present invention should be defined by the protection scope of the appended claims.

What is claimed is:

1. A method of software component identification in an embedded system firmware, the method comprising the steps of:
(a) receiving a firmware file;
(b) extracting an indicator file from the firmware file;
(c) extracting features from the indicator file, wherein the features comprise the following information:
a hash value;
semantic information;
control flow graph information; and
function-level feature information;
(d) comparing the features of the indicator file with a database to derive an indicator file identification result; and
(e) repeating steps (b) to (d) to obtain a plurality of indicator file identification results for determining a software component identification result of the firmware file.

2. The method according to claim 1, wherein the indicator file is an executable file, a library file, or a configuration file.

3. The method according to claim 1, wherein the step (c) further comprises the following steps to extract the flow graph information:
(c1) disassembling the indicator file to generate a disassembled file;
(c2) converting the disassembled file into an intermediate representation file;
(c3) identifying each function entry point based on the intermediate representation file; and
(c4) detecting jumps, branches, or returns in the intermediate representation file so as to derive a plurality of nodes, directed edges, caller and callee information to form the control flow graph information.

4. The method according to claim 1, wherein the step (c) further comprises the following steps to extract the function-level feature information:
(c5) disassembling the indicator file to generate a disassembled file;
(c6) converting the disassembled file into an intermediate representation file;
(c7) extracting a plurality of function names from the intermediate representation file; and
(c8) extracting a plurality of readable strings from the intermediate representation file;
wherein the function-level feature information is obtained according to the plurality of function names and readable strings.

5. The method according to claim 1, wherein the step (c) further comprises the following steps to extract the semantic information:
(c9) extracting a plurality of strings from the indicator file;
(c10) disassembling the indicator file to generate a disassembled file;
(c11) converting the disassembled file into an intermediate representation file; and
(c12) extracting a plurality of external library names from the intermediate representation file; wherein the semantic information is obtained according to the plurality of strings and external library names.

6. The method according to claim 1, wherein the step (d) further comprises:
(d1) comparing the hash value of the indicator file with the database, if the hash value is found in the database, the indicator file with the same hash value found in the database is designated as the indicator file identification result;
(d2) comparing the semantic information of the indicator file with the database to obtain a plurality of candidate indicator files;
(d3) comparing the control flow graph information and the function-level feature information of the indicator file with the plurality of candidate indicator files, calculating a similarity score and a confidence score between the indicator file and the plurality of candidate indicator files; and
(d4) when the similarity score of the candidate indicator file with the highest similarity and confidence score is greater than or equal to a first threshold, and the confidence score is greater than or equal to a second threshold, selecting the candidate indicator file as the indicator file identification result.

7. The method according to claim 6, the method further comprises:
when the similarity score of the candidate indicator file with the highest similarity and confidence score is less than the first threshold, or the confidence score is less than the second threshold, adding a new entry of indicator file data to the database based on the features of the indicator file extracted in step (c).

8. The method according to claim 1, the method further comprising:
extracting a package management file from the firmware file and determining the software component identification result based on the package management file.

9. The method according to claim 1, wherein the firmware file is a Linux-based embedded system firmware file.

10. A system of software component identification in an embedded system firmware, comprising:
an indicator file extraction module to receive a firmware file and extract an indicator file from the firmware file;
a feature extraction module to extract features from the indicator file, wherein the features comprise the following information:
a hash value;
semantic information;
control flow graph information; and
function-level feature information;
a database comprising a plurality of known software components, along with the features of each known indicator file within each known software component; and
an indicator file identification module to compare the features of the indicator file with the database to derive an indicator file identification result.

11. The system according to claim 10, wherein the indicator file is an executable file, a library file, or a configuration file.

12. The system according to claim 10, wherein the indicator file extraction module further extracts a plurality of indicator files and the system further comprises:
a software component identification module to determine a software component identification result of the firmware file based on the indicator file identification results of the plurality of indicator files.

13. The system according to claim 10, wherein the feature extraction module further comprises:
a hash value calculation module to calculate a hash value of the indicator file;
a disassembler module to disassemble the indicator file and generate a disassembled file;
a function-level feature information and control flow graph information extraction module to extract function-level feature information, control flow graph information, and external library name information based on the disassembled file; and
a semantic information extraction module to extract semantic information based on the indicator file and the external library name information.

14. The system according to claim 13, wherein the function-level feature information and control flow graph information extraction module further comprises:
an intermediate representation conversion module to perform intermediate representation conversion on the disassembled file, generate an intermediate representation file;
a symbolic information extraction module to extract symbolic information comprising function names, external library names, and variable names from the intermediate representation file;
a function prologue extraction module to detect function prologue;
a function entry point extraction module to identify the function entry points in the intermediate representation file based on the output of the symbolic information extraction module and the function prologue extraction module;
a control flow graph information extraction module to derive control flow graph information of the indicator file based on the function entry points, wherein the control flow graph information comprises nodes, directed edges, caller, and callee information; and
a function-level feature information extraction module to generate function-level feature information of the indicator file based on the readable strings extracted from a function and the function names output by the symbolic information extraction module.

15. The system according to claim 10, wherein the indicator file identification module is further configured to perform the following functions:
comparing the hash value of the indicator file with the database, if the has value is found in the database, the indicator file with the same hash value found in the database is designated as the indicator file identification result;
comparing the semantic information of the indicator file with the database to obtain a plurality of candidate indicator files;
comparing the control flow graph information and the function-level feature information of the indicator file with the plurality of candidate indicator files, calculating a similarity score and a confidence score between the indicator file and the plurality of candidate indicator files; and
when the similarity score of the candidate indicator file with the highest similarity and confidence score is greater than or equal to a first threshold, and the confidence score is greater than or equal to a second threshold, selecting the candidate indicator file as the indicator file identification result.

16. The system according to claim 15, the system further comprising:
a database update module to add a new entry of indicator file data to the database when the similarity score of the candidate indicator file with the highest similarity and confidence score is less than the first threshold, or the confidence score is less than the second threshold.

17. The system according to claim 15, the system further comprising:
a package management file extraction module to extract a package management file from the firmware file and determine the software component identification result based on the package management file.

18. The system according to claim 10, wherein the firmware file is a Linux-based embedded system firmware file.
